(19) United States
(12) Patent Application Publication
(10) Pub. No.: US 2009/0277893 A1
(43) Pub. Date: Nov. 12, 2009

(54) WELDING POWER SUPPLY WITH SCALED OUTPUT VOLTAGE

(76) Inventor: Brandon John Speilman, Kaukauna, WI (US)

Correspondence Address: QUARLES & BRADY LLP, 411 E. WISCONSIN AVENUE, SUITE 2040, MILWAUKEE, WI, 53202-4497, US

(21) Appl. No.: 12/119,001

(22) Filed: May 12, 2008

(51) Int. Cl. B23K 9/10

(52) U.S. Cl. 219/137.71

(57) ABSTRACT

A method and system for adjusting the output voltage applied to a wire electrode during an automatic parameter selection mode in which the rate of advancement and output voltage is automatically determined. A control circuit determines appropriate power parameters in response to at least one configuration parameter. The control circuit generates a power command accordingly based on an expected, or nominal, input voltage. A sensor connected to the control circuit monitors the actual input voltage. If the actual input voltage is outside of an acceptable range, the control circuit scales the generated power command with a scaling factor calculated based on the actual input voltage.

### REFERENCE TO RELATED APPLICATIONS

Not applicable.

### STATEMENT REGARDING FEDERALLY SPONSORED RESEARCH OR DEVELOPMENT

Not applicable.

### BACKGROUND

The present invention relates generally to wire-feed welding devices and, more specifically to methods and systems for adjusting automatically set welding parameters in response to out-of-range input voltage levels.

A common metal welding technique employs the heat generated by electrical arcing to transition a workpiece to a molten state to facilitate a welding process. One technique that employs this arcing principle is wire-feed welding. At its essence, wire-feed welding involves routing welding current from a power supply into an electrode that is brought into close proximity with the workpiece. When close enough, current arcs from the electrode to the workpiece, completing a circuit and generating sufficient heat to weld the workpiece. Often, the electrode is consumed and becomes part of the weld itself. Thus, new wire electrode is advanced, replacing the consumed electrode and maintaining the welding arc. If the welding device is properly adjusted, the wire-feed advancement and arcing cycle progresses smoothly, providing a good weld.

Conventionally, an operator uses their knowledge and acumen to manually select the most appropriate weld settings, such as the output voltage and wire feed advancement rate (i.e., wire speed), based on known parameters including the wire electrode diameter, electrode material, and the thickness of the material to be welded. However, oftentimes, the weld operator is a novice, especially in the case of portable welding devices. If the operator does not properly select the voltage and wire-feed rate settings, the arcing may not be sufficient to produce a good weld, or even a weld at all. Furthermore, in traditional welding machines, the wire-feed speed control and the voltage control are wholly independent from one another, thus making it difficult for the operator to adjust either parameter while a weld is progressing.

In response to these needs, a number of welding systems have been developed having an operating mode in which a number of the operating parameters are automatically set based on operator input. One such commercially available welding system is the Millermatic® 180 Auto-Set™ MIG arc welder. Millermatic and Auto-Set are trademarks of Illinois Tool Works, Inc of Glenview, Illinois. As described in greater detail below, an operator manually inputs the weld-wire diameter and thickness of the material to be welded before striking an arc. Based on these inputs, the control circuitry determines the appropriate operating parameters including, but not limited to, the wire-feed advancement rate and the output voltage and automatically sets these parameters accordingly. As a result, the need for any guesswork, educated or otherwise, by the operator is eliminated. Metal inert gas (MIG) arc welders incorporating the Auto-Set™ system, or similar automatic parameter setting control systems, have become popular.

Some transformer-based MIG arc welders or cutting machines incorporating automatic welding parameter setting capabilities are designed for a particular nominal sinusoidal input voltage such as 2001208V, 230/240V, 380/415V, 460/480V, 500V or 575V. The supplies may be either single-phase or three-phase and either 50 or 60 Hz. Welding power supplies receive one of the nominal inputs and produce an approximately 10-40 volt DC high current welding output.

As long as the input voltage to the welding machine is within an acceptable range of the nominal voltage the machine is designed to accept, the automatically set operating parameters, and thus the welding operation, remain relatively unaffected. However, if the input voltage deviates outside of the acceptable range, the operating parameters are affected, typically with adverse consequences such as poor welding performance. Further, components that operate safely at a particular input voltage may be damaged when operating at an alternative input voltage. Fluctuating and out-of-range input voltages are a problem in developing countries, but even modern countries may have surges and spikes on their power grids for various reasons.

One of the operating parameters that may be adversely effected by an out-of-range input voltage is the output voltage produced by the power supply. If the input voltage dips below an acceptable level, the output voltage consequently becomes lower than the automatically set (and commanded) output voltage. If the input voltage rises above an acceptable level, the output voltage consequently becomes higher than the commanded voltage. If the difference between the nominal input voltage for the welding machine and the actual input voltage becomes too great, an unstable welding voltage for a set welding parameter may occur.

Some transformer-based power supplies in the prior art accommodate for varying input voltages by employing circuits that can be manually adjusted to accommodate a variety of inputs. These circuits generally may be adjusted by changing the transformer turns ratio, changing the impedance of particular circuits in the power supply or arranging tank circuits to be in series or in parallel. In these prior art devices, the operator was required to identify the voltage of the input and then manually adjust the circuit for the particular input. Besides other operational problems, these devices do not help when an input voltage deviates greatly from the nominal voltage.

Therefore, other transformer-based power supplies were developed that monitor the output voltage and adjust the firing angle of silicon controlled rectifiers (SCRs) to regulate the output voltage accordingly. In some welding systems, control of the SCR firing angle is effectuated by a closed-loop, feedback control scheme, in which the firing angle varies based on the voltage output feedback returned to the controller. That is, in these systems, the calculated SCR firing angle takes into account both a command or desired output voltage signal and a feedback voltage during operation. The system then constantly compares the two and attempts to maintain the set or desired output voltage. Unfortunately, even when actively controlled, the difference between the nominal input voltage and the actual input voltage may result in extinguishing of the welding arc or delay in establishment of the arc, or otherwise generally erratic operation, as the controller attempts to compensate. Moreover, this variance can lead to increased weld spatter, flaring, stumbling, torch pushback, among other undesirable problems.

Therefore, there exists a need for an improved system for adjusting the automatically set output voltage of a transformer-based welding machine in response to out-of-range input voltage conditions.

### SUMMARY

The present invention overcomes the aforementioned drawbacks by providing a method and system for automatically adjusting the output voltage of a welding power supply in response to an out-of-range input voltage.

In accordance with one aspect of the present invention, a welding system is disclosed that includes a power supply operable to output power within a range of power levels in response to a command. The welding system further includes an input device operable to select a welding parameter. The selectable welding parameters may include the diameter of the consumable wire electrode used, the thickness of the material being welded, the output voltage, or the advancement rate for the wire electrode. The welding system further includes a voltage sensor operable to sense the power supply input voltage and a controller. The controller determines an appropriate output power level based on the welding parameter selected with the input device. Further, the controller generates an output power command to produce the determined output power level. Still further, the controller uses the selected welding parameter to determine whether the welding system is operating in a manually selected output power level mode or an automatically selected output power level mode. If the welding system is in automatically selected output power level mode and an out of range input voltage is sensed by the voltage sensor, the controller adjusts the generated output power command accordingly.

In accordance with another aspect of the present invention, a method of operating a welding system includes applying an output voltage to a welding electrode. The output voltage is automatically determined based on a welding parameter selected with an input device. The method further includes monitoring an input voltage to the welding system and adjusting the automatically determined output voltage if an out-of-range input voltage is detected.

Various other features of the present invention will be made apparent from the following detailed descriptions and drawings.

### DRAWINGS

The invention will hereafter be described with reference to the accompanying drawings in which like reference numbers represent like elements throughout the drawings, and wherein:

FIG. 1 is a diagrammatic representation of a welding system constructed in accordance with the present invention;

FIG. 2 is a schematic representation of a scaled output voltage control circuit for the welding system of FIG. 1; and

FIG. 3 is a flowchart setting forth the steps of operating a welding system having automatically set operating parameters in accordance with an embodiment of the invention.

### DETAILED DESCRIPTION

In accordance with an exemplary embodiment, a method and system adjusts an automatically set output voltage of a welding device in response to an out-of-range input voltage. This invention may be used, for example, in a metal-inert-gas (MIG) welding system having an operating mode whereby operating parameters such as wire feed speed and welding output voltage are automatically set in response to user inputs. These inputs may include, but are not limited to, the diameter of the consumable wire electrode and the thickness of the material to be welded.

As discussed above, many MIG welding systems are designed for a specific nominal input voltage and do not monitor the actual input voltage. In such systems, regardless of the actual input voltage, the nominal input voltage, along with a measured output voltage is used by a controller to set the SCR firing angle and potentially other control parameters.

Such a control methodology works well when the supplied power is stable and within an acceptable range. However, if the input voltage to the welding system fluctuates, spikes, or drifts too far from the nominal voltage, an undesirable welding condition and even damage to the system components may occur. Thus, according to the exemplary implementation, the input voltage to the welding system is monitored and if an out-of-range voltage condition is detected, an automatically set output voltage is scaled in response to ensure desirable welding conditions.

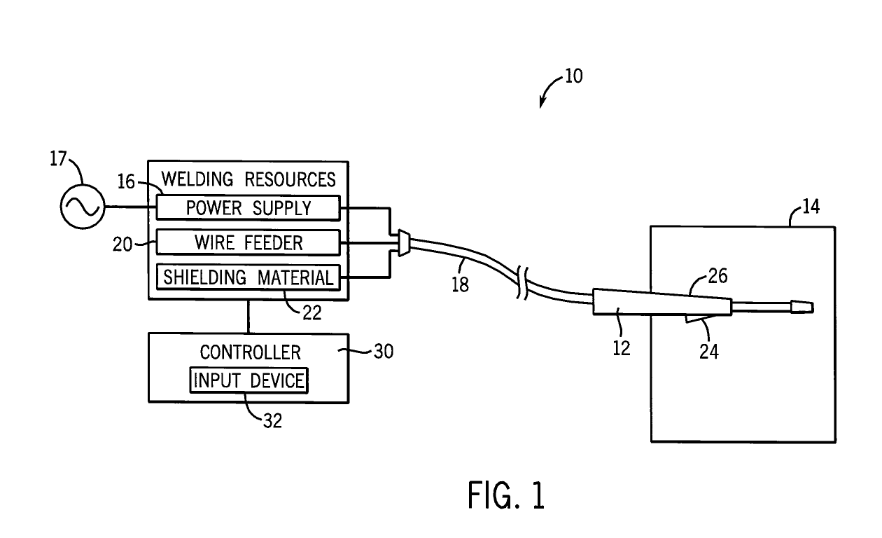

FIG. 1 illustrates a welding system 10 that includes an exemplary implementation of scaled output voltage control. The system 10 may be configured for portable use, and such systems are often operated by less-experienced operators. However, the following discussion merely relates to exemplary embodiments of the present invention. Thus, the appended claims should not be viewed as limited to those embodiments described herein.

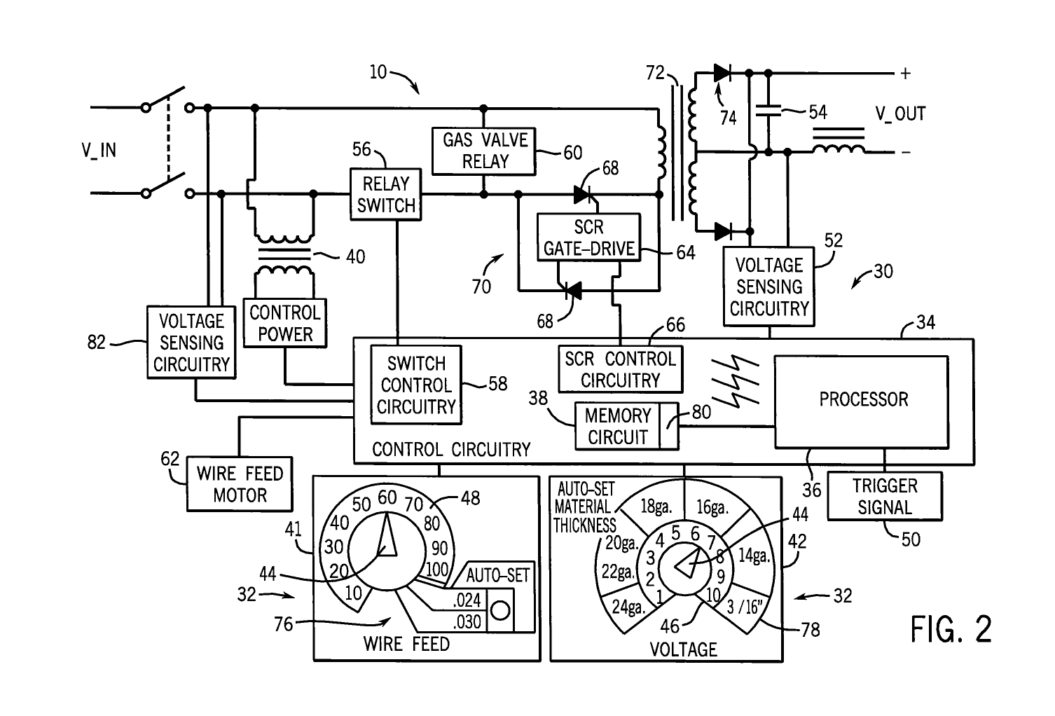

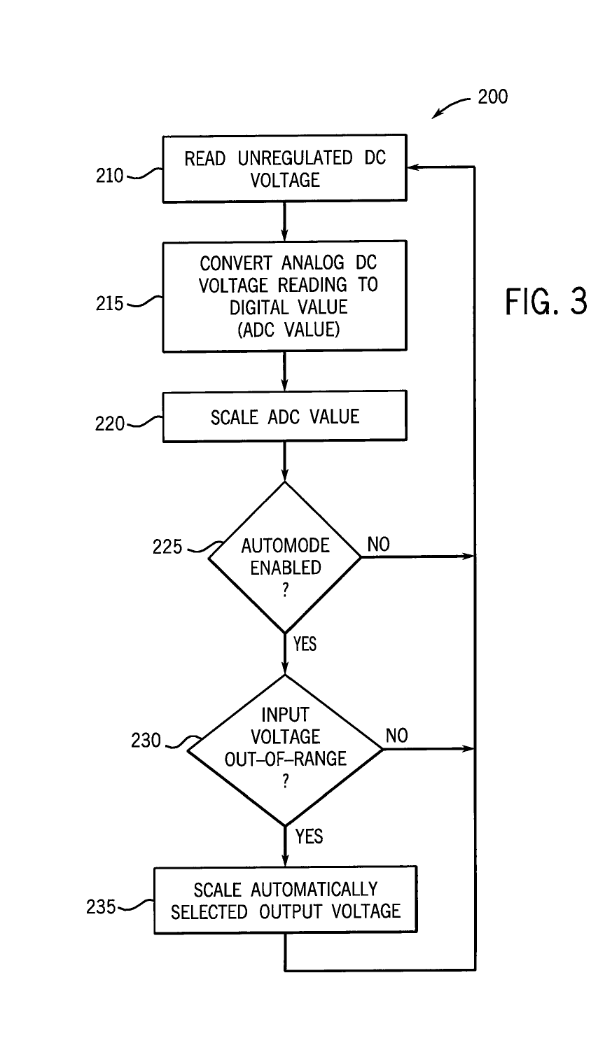

The welding system 10 includes a welding torch 12 that defines the location of the welding operation with respect to a workpiece 14. A power supply 16 converts incoming AC power 17 to an appropriate DC power for a welding operation as described with reference to FIGS. 2 and 3. A welding cable 18 is coupled between the power supply 16 and the welding torch 12. Placement of the welding torch 12 at a location proximate to the workpiece 14 allows electrical current provided by the power supply 16 to be delivered to the welding torch 12 via the welding cable 18. Although not shown, the welding torch 12 conducts electrical current to a consumable wire electrode via a contact tip located in the neck assembly, leading to arcing between the egressing wire electrode and the workpiece 14. This resulting arc completes an electrical circuit including with the power supply 16, welding cable 18, welding torch 12, wire electrode, the workpiece 14, and ground, typically at the power supply 16. The arcing generates a relatively large amount of heat causing the workpiece 14 and/or the filler metal of the electrode to transition to a molten state, thereby facilitating the weld.

To shield the weld area from contaminants during welding as well as enhance arc performance and improve the resulting weld, the welding system 10 includes a gas source 22 that feeds an inert shielding gas to the welding torch 12 via the welding cable 18. However, a variety of shielding materials, including various fluids and particulate solids, or no shielding material at all, may be employed.

Delivery of the welding current, consumable wire electrode, and shielding gas is effectuated by actuation of a trigger 24 secured to a handle 26 on the welding torch 12. By depressing the trigger 24, an electrical signal is transmitted through the welding cable 18 to a controller 30, which in turn commands delivery of the welding resources to the welding torch 12. To facilitate adjustment of the operating parameters of the welding system 10 in either a manual parameter selection mode or an automatic parameter selection mode, the controller 30 includes at least one input device 32.

FIG. 2 is a simplified schematic of the welding system controller 30 of FIG. 1 in relation to various other components of the welding system 10. As illustrated, the exemplary controller 30 includes control circuitry 34 that receives a number of inputs, processes the inputs, and provides output commands within the welding system 10. To effectuate this control, the control circuitry 34 includes a processing device, such as a processor 36 or a programmable logic controller (PLC). The processor 36 communicates with a memory circuit 38 which stores operational data as well as user-selected data or settings. The control circuitry 34 receives control power conditioned to an appropriate level from the main power input (V_IN) by a control power transformer 40. The processor 36 may determine the waveform, and thus, the amplitude of the input power via the input control power or via a separate input signal, and use these identified points as discussed further below.

The welding system 10 further includes a pair of user-selectable input devices 32 designed to receive power parameters or configuration parameters. In the illustrated configuration the user-selectable input devices 32 include a first user interface 41 and a second user interface 42. As will be described, when operating in a manual control mode, the first user interface 41 operate as a wire-feed speed controller and the second user interface 42 operates as an output voltage controller. As will be described below, when operating in the automatic control mode, the user-selectable input devices 32 operate to receive configuration parameters that are not directly related to power parameters, such as wire gauge. Hence, as defined herein, power parameters are parameters that directly relate to the characteristics of the output power generated by the welding system 10, including power, current, and voltage. In addition, because wire-feed speed is typically directly related to current, wire-feed speed is considered a power parameter.

As illustrated, these input devices 32 are potentiometers; however, other kinds of input devices, such as keypads and digital encoders, are also contemplated. Each user interface 41, 42 includes a selector dial 44 positionable between indexed locations corresponding to a set of power parameters for the manual power parameter selection.

Specifically, in manual parameter selection mode, the operator can manually control the output voltage to the wire electrode by turning the dial 44 on the second user interface 42 between indexed positions labeled from “1” to “10” in a voltage selection graphic 46. If an output voltage closer to forty volts is desired, the dial 44 can be turned to the “10” position. Conversely, if less output voltage is desired, the second user interface 42 can be turned to the “1” position. Similarly, the wire-feed speed of the system 10 can be manually adjusted by turning the dial 44 on the first user interface 41 between the “10” and “100” positions displayed on a wire speed selection graphic 48. In one embodiment, the “10” position is a lowest operating wire-feed speed (for example, 75 inches per minute) and “100” position is the fastest (for example, 1400 inches per minute). Again, it should be noted that since, typically, wire-feed speed is directly related to the current characteristics of the output power, wire-feed speed is a power parameter.

The controller 30 also receives an input from the trigger 24. As discussed above, depressing the trigger 24 transmits an activation signal to the controller 30. The activation or trigger signal, designated by reference numeral 50 in FIG. 2, is continuously received by the control circuitry 34, signifying that an operational welding state is desired. When the trigger 24 is released, the signal 50 ceases and the welding system 10 transitions to a deactivated or non-operational state. The main control circuitry 34 receives a still further input from output voltage sensing circuitry 52. The output voltage sensing circuitry 52 provides feedback regarding the voltage levels outputted by the power supply 16 during operation. The output voltage sensing circuitry 46 senses the output voltage of the system 10 across a dampening capacitor 54.

In response to these inputs the control circuitry 34, including the processor 36, controls various components of the welding system 10. For example, a relay switch 56 is actuated via switch control circuitry 58, thereby sending a signal to a gas valve relay. The relay 60 opens or closes a gas valve (not shown) to activate or deactivate the flow of the shielding material such as gas from the shielding material source 22. The main control circuitry 34 also controls a wire feed motor 62 which drives and regulates the advancement of the wire electrode into the welding cable 18 by the wire feeder 20.

Additionally, the main control circuitry 34 controls an SCR gate driver 64 through SCR control circuitry 66. Specifically, the SCR control circuitry 66 provides the desired firing angle, or controlled switching rate, to the SCR gate driver 64 to control the output power. The output voltage of the welding system 10 is produced by controlling the switching time period and of the SCRs 68 which is determined, at least in part, by the second user interface 42. Thus, input power is routed through an SCR assembly 70 having SCRs 68 operated by the SCR gate driver 64, conditioned by a main transformer 72, rectified by a rectifier 74, filtered by the capacitor 54, and provided for operational use by the welding system 10.

When the welding system 10 is operated in manual parameter selection mode, the operator must rely on his or her welding acumen to select the appropriate output voltage level and wire feed speed based on the type of weld to be made, the kind and size of the wire electrode, and other relevant factors. Many operators, however, do not have the breadth of experience and knowledge generally beneficial to make such decisions and maladjustment of the welding system 10 is possible. For example, if the wire feed speed setting is too slow in comparison to the voltage level setting, an arc may not form or may extinguish prematurely. Conversely, if the wire-feed speed setting is too fast for the given voltage level setting, the quality of the resultant weld may be reduced. Additionally, when the system 10 is in the manual parameter selection mode, an operator may benefit from adjustments in the voltage setting, which, in turn, benefits from adjustments in the wire-feed speed setting. Unfortunately, the operator may find it too difficult to maintain the arc by depressing the trigger 24 while concurrently manipulating both the first user interface 41 and the second user interface 42.

To alleviate such concerns, the exemplary welding system 10 includes the aforementioned automatic operating parameter selection mode. When the welding system 10 is operating in the automatic parameter selection mode, the first and second user interfaces 41, 42 function as configuration parameter selection inputs. That is, the user interfaces 41, 42 are no longer used to select power parameters as described above. Rather, the first user interface 41 is used to communicate the weld-wire diameter that is to be used during the welding process. Accordingly, as illustrated in FIG. 2, the first user interface 41 has associated therewith a configuration parameter graphic 76 that includes two selectable weld-wire diameter settings of 0.024 inch and 0.030 inch, but may include any suitable set of configuration parameters. Selecting either of these two wire diameters with the first user interface 41 transitions the welding system 10 from manual parameter selection mode into automatic parameter selection mode.

Furthermore, the second user interface 42 is used to select the thickness of the material to be welded via a range of different thickness measurements displayed on a second configuration parameter graphic 78. In the embodiment shown, the selectable material thicknesses shown on the graphic 78 include 24 ga, 20 or 22 ga, 18 ga, 16 ga, 14 ga, and ⅛″ or 3/16″. Although not shown, other possible material thicknesses settings include 5/16″, ¼″ ⅜″, ½″, and so on.

In automatic parameter selection mode, power parameters are no longer selected by the user. Rather, the controller 30 determines appropriate output power characteristics, including current, voltage, and wire-feed speed, based on the user inputted configuration parameters, including wire diameter size and thickness of the material to be welded. For example, if a wire diameter of 0.024″ and a material thickness of 24 gauge is selected, the controller 30, via the processor 36 and data stored in the memory 38, determines the appropriate output voltage and wire speed/current. These determinations can be made via the use of a look-up table 80 stored in the memory 38 or can be made via the use of an appropriate algorithm, among various other correlation techniques. If the operator subsequently selects a different configuration parameter, such as a different wire diameter size or material thickness, the controller 30 determines a new output voltage and wire speed/current and responds accordingly.

As discussed above, the firing angle command generated by the controller 30 controls the SCR gate driver 64 to produce the determined output voltage. In the automatic parameter selection mode, the firing angle command is at least partially based on a nominal or ideal input voltage rating for the welding system 10. Feedback from the output voltage sensing circuitry 46 may also be used to control the firing angle. However, if the input voltage becomes significantly higher or lower than the nominal voltage rating or has rapid fluctuations, the feedback from the output voltage sensing circuitry 46 may not be sufficient to prevent undesirable welding conditions.

Consequently, input voltage sensing circuitry 82 is provided to measure the input voltage delivered to the welding system 10 and transmit the input voltage measurement to the controller 30. The additional voltage measurement from the input voltage sensing circuitry 82 is used by the controller 30 to produce a stable output voltage when the welding system 10 is operating in the automatic parameter selection mode. If the sensed input voltage is within an acceptable range, the firing angle set by the processor 36 to produce the determined output voltage is not adjusted. If the input voltage is outside of an acceptable range, the firing angle command is scaled up or down accordingly.

In one embodiment, the input voltage sensing circuitry 82 measures a rectified waveform of the input voltage. The circuitry 82 scales the rectified input voltage down to a 1-5 VDC range which is then read by an analog-to-digital converter (ADC) input channel of the microprocessor 36. The ADC converts the voltage input into a digital value for analysis by the microprocessor 36. Software embedded in the microprocessor 36 determines an appropriate scaling factor value relative to the acceptable input voltage range.

When the welding system 10 is operating in the automatic parameter selection mode and an out-of-range input voltage is detected, the firing angle command generated to produce the previously determined output voltage is scaled via the scaling factor. The automatically determined output voltage (determined via the lookup table 80 or an algorithm) is not itself modified, however.

For example, if the actual input voltage is determined to be higher than an acceptable level, the generated firing angle command to the SCR gate drive 64 is scaled with the scaling factor to lower the output voltage. If the actual input voltage is determined to be less than an acceptable level, the firing angle command to the SCR gate drive 64 is scaled appropriately to drive the output voltage higher.

FIG. 3 includes one embodiment of a process 200 for scaling an output voltage that may be employed in a welding system 10 having an automatic parameter selection mode. Starting in step 210, the input voltage to the welding system 10 is rectified, scaled, and read into an analog-to-digital input channel of the microprocessor 36. In step 215, the rectified and scaled input voltage is converted into a multiple bit digital value by the microprocessor 36. In step 220, a scaling factor is calculated with software embedded in the microprocessor 36 of FIG. 2.

As shown in steps 225, if the welding system 10 of FIGS. 1 and 2 is operating in the automatic parameter selection mode, the process 200 moves to step 230 to determine whether to apply the scaling factor to the output voltage (firing angle) command. However, if the welding system 10 is operating in the manual parameter selection mode, the scaling factor is not used regardless of the input voltage. Instead, the process returns to step 210 and the user may manually adjust the voltage, wire feed, or other setting if appropriate. In step 230, if the input voltage is determined to be outside of a preset range, the output voltage command is scaled accordingly in step 235 with the scaling factor. The process 200 operates continuously while the welding system 10 is providing welding power.

The present invention recognizes the advantages of controlling the system based on monitoring the input power as opposed to the output power. Monitoring the output voltage to determine whether and how to augment the firing angle, unexpectedly, does not yield sufficiently accurate control. However, utilizing the rectified input voltage to determine adjustments to the firing angle unexpectedly yields much greater and more accurate control. It is also contemplated that both the input and output voltages may be utilized to determine adjustments to the firing angle.

The present invention has been described in terms of the various embodiments, and it should be appreciated that many equivalents, alternatives, variations, and modifications, aside from those expressly stated, are possible and within the scope of the invention. Therefore, the invention should not be limited to a particular described embodiment.

I claim:

1. A welding system comprising:
a welding-type power source configured to receive an input power and having a transformer configured to convert the input power to an output power to drive a welding-type process;
a user input configured to receive a desired configuration parameter from a range of configuration parameters;
a voltage sensor configured to monitor the input power received by the power source and generate an input power feedback signal;
a controller configured to receive the desired configuration parameter and the input power feedback signal and programmed to:
determine output power characteristics including current and voltage levels based on the desired configuration parameter;
generate a control signal configured to control the welding-type power source to deliver an output power having the determined output power characteristics when receiving an ideal input power; and
scale the control signal in response to the input power feedback signal to cause the welding-type power source to deliver the output power having the determined output power characteristics when receiving an input power deviating from the ideal input power beyond a threshold value.

2. The welding system of claim 1, wherein the controller is further programmed to compare the input power feedback signal to a predetermined range of input voltages and only scale the control signal when the input power feedback signal is outside the predetermined range.

3. The welding system of claim 1, wherein the transformer has a primary side configured to receive the input power and a secondary side configured to deliver the output power and further comprising a plurality of switches arranged on the input side and configured to switch at a switching frequency designated by the control signal.

4. The welding system of claim 1, wherein the configuration parameter selectable with the user input comprises one of: a consumable wire electrode diameter and a material thickness.

5. The welding system of claim 4, further comprising another user input operable to select another configuration parameter.

6. The welding system of claim 5, wherein the output power characteristics and the output power having the determined output power characteristics is determined based on the configuration parameters selected with the user input and the another userinput.

7. The welding system of claim 1, further comprising a rectifier configured to rectify the input power and wherein the voltage sensor is configured to monitor the rectified input power to generate the input power feedback signal.

8. A method of operating a welding system comprising:
selecting a desired configuration parameter from a range of configuration parameters;
determining output power characteristics including current and voltage levels based on the desired configuration parameter and an ideal input power;
generating a control signal configured to control a welding-type power source having a transformer to deliver an actual output power having the determined output power characteristics when receiving the ideal input power;
providing an actual input power to the welding-type power source configured to convert the actual input power to an output power;
monitoring the actual input power received by the power source; and
comparing the actual input power to the ideal input power; and
scaling the control signal to cause the welding-type power source to deliver the output power having the determined output power characteristics when the actual input power deviates from the ideal input power beyond a predetermined threshold value.

9. The method of claim 8, wherein the determined power characteristics include at least two of output voltage, output current, and wire-feed speed.

10. The method of claim 8, wherein the configuration parameters include a consumable wire electrode diameter and a material thickness.
